(19) United States
(12) Patent Application Publication
(10) Pub. No.: US 2006/0031231 A1
(43) Pub. Date: Feb. 9, 2006

(54) System and method for simplified retrieval of data objects

(75) Inventors: Walter Nagler, Auerbach (DE); Matthias Lochner, Bindlach (DE); Alexander Lang, Parkstein (DE); Stefan Knoll, Auerbach (DE)

Correspondence Address: HUNTON & WILLIAMS LLP, 1601 BRYAN STREET, ENERGY PLAZA - 30TH FLOOR, DALLAS, TX, 75201, US

(73) Assignee: Cherry GmbH, Auerbach/Opf. (DE)

(21) Appl. No.: 11/198,306

(22) Filed: Aug. 8, 2005

(30) Foreign Application Priority Data
Aug. 9, 2004 (DE) 102004038627.7-53

(51) Int. Cl. G06F 17/30

(52) U.S. Cl. 707/10

(57) ABSTRACT

The present disclosure relates to a system and method for simplified retrieval of data objects using a computer in a network. The activation of a key of an input device is detected by a program for detecting input, and a secondary network address associated with the activated key is transmitted to a network access program. This program loads a data object containing the network address of a primary data object from the secondary network address, which may be accessed by the user.

### CROSS REFERENCE TO RELATED APPLICATIONS

This utility application claims priority to prior-filed copending application No. DE 10 2004 038 627.7-53 filed Aug. 9, 2004

### FEDERALLY SPONSORED RESEARCH OR DEVELOPMENT STATEMENT

N/A

### REFERENCE TO SEQUENCE LISTING

N/A

### FIELD OF THE DISCLOSURE

The present disclosure relates to a system and method for simplified retrieval of data objects using a computer.

### BACKGROUND OF THE DISCLOSURE

Addresses of data objects which are accessible via networks are often only valid for a very limited period of time. This is particularly true for home pages accessible via the internet, but also for programs and other data objects which are offered to be downloaded via the internet. The addresses of these objects may change as objects are added, modified, relocated or deleted.

Furthermore, due to the limited availability of concise alphanumeric addresses the addresses of such data objects also tend to get longer and more complicated. Often the addresses of objects which have nothing in common differ only in very few characters.

In order to solve the latter problem, many network access programs, in particular browser programs for the World Wide Web (WWW), offer so-called bookmark lists, in which the addresses of data objects are stored using memorable names that thus may be easily retrieved again.

In particular, large bookmark lists are susceptible, however, to the problem that the addresses stored in them are only valid for a limited period of time. Therefore, to keep such lists up to date requires a high amount of time by the user.

Another approach to simplify the access to network addresses are computer keyboards, which have been available for some time, having additional keys in besides the usual keys of computer keyboards, which cause the execution of special functions by the computer. Some of these additional keys usually cause a browser program to be started and a homepage to be opened by the program, wherein the address of the homepage is either permanently specified or can be preset by the user.

However, such computer keyboards also have the problem that the network addresses by which they are accessed may change. In the case of permanently specified addresses, thus the additional key loses its function; in the case of a settable address, the user has again the task to keep the addresses up to date.

From EP 1 285 359 a method is known in which network addresses of data objects are stored on a centralized server where they may be kept up to date. In order to access these addresses, the user has to enter a secondary network address consisting of an alphanumeric prefix (i.e. the address of the centralized server) and a numeric suffix. The user also has to carry out an additional input; depending on this input the secondary address is mapped onto a primary address. Finally, the data object may be accessed using the primary address. This method has a drawback in that the user has to memorize the secondary addresses or has to manage them in a list. Moreover, an additional input is necessary.

### SUMMARY OF THE DISCLOSURE

It is therefore an object of the present disclosure to provide a system and a method enabling a user to access data objects in a simplified manner without the user having to take care of the up-to-dateness of the network addresses of these objects.

This object is solved by a system and method for simplified retrieval of data objects according to the present disclosure.

A network address for the purposes of the present disclosure refers to a numeric, alphanumeric or otherwise encoded string of characters which uniquely identifies a data object in a network. The usual network addresses consist of a plurality of portions, e.g. the network address of a data object may be “http://www.a-computer.de/path/to/data-object.html”. Herein “http://” indicates the network protocol by which the data object should be accessed. “www.a-computer.de” is the network address of the computer storing the data object. “/path/to/” indicates the storage location in the structure of directories of the computer, and “data-object.html” identifies the data object. For the purposes of the present disclosure a network address may additionally also have parameters identifying the data object. As an example, “http://www.a-computer.de/path/to/data-object.cgi?file=datafile.html” is the network address of a data object having the name of “data-object.cgi”, to which the assignment “file=datafile.html” is passed as a parameter and which then forwards the user to the data object having the name “datafile.html”. A data object may also be identified not only by one, but by a plurality of parameters.

A system according to the present disclosure comprises an input device for a computer, which comprises at least one key. The system further comprises a program for detecting input which may be executed on the computer and which comprises means for detecting which key of the input device is activated, and means for transmitting a network address associated with the activated key to a network access program (e.g. a WWW-browser, an FTP-program or any other network access program). The network access program accesses the network address transmitted to it and downloads a preliminary (secondary) data object therefrom, which contains the network address of the final (primary) data object that the user wishes to access.

The input device can be for example a keyboard, a mouse, a touch-pad, a joystick, a game-pad, a PDA or any other input device, which usually comprises keys and/or is provided with additional keys. It may be linked to the computer via a cable and/or via a wireless connection.

As soon as a key of the input device is activated, the program for detecting input receives a notification generated by the corresponding driver program, as to which key has been activated and checks whether a network address is associated with this key.

If the key, which is activated on the input device, is not associated to a network address, the program for detecting input passes on the notification that this key has been activated to the operating system of the computer without any modification so that the program for detecting input appears transparent to this type of keys.

If the activated key has a network address associated with it, the program for detecting input transmits the address to a suitable network access program (e.g. an WWW-browser for http addresses, an FTP-program for ftp addresses) if such a program is already running. If a suitable program is not yet running, it will be started by the program for detecting input and the network address will be transmitted to the network access program simultaneously or after start-up.

The program for detecting input and the network access program may run on the same computer or on different computers, which may communicate with each other.

In a preferred embodiment, the secondary data object contains the network address of exactly one primary data object. The secondary data object may be configured in such a way that the network access program is automatically forwarded to the network address of the primary data object. Herein the forwarding may either be done without alerting the user so that he/she is not aware that the secondary data object is loaded, or the network access program may indicate that a forward to the primary data object takes place. The secondary data object may be configured, however, in such a way that the network access program displays the network address of the primary data object and forwarding is only carried out once it has been confirmed by the user (e.g. by clicking the mouse on the address of the primary data object or by an input on the keyboard).

In another preferred embodiment, the secondary data object contains the network addresses of a plurality of primary data objects. In that case, the addresses of the primary data objects will be displayed by the network access program, and the user has to choose which primary data object he/she wants to access (e.g. by clicking the address with the mouse or by an input on the keyboard).

In another preferred embodiment, the network addresses of primary data objects contained in the secondary data object are permanently specified. The user may not influence which network addresses are displayed to him/her or to which network addresses he/she is forwarded.

In another preferred embodiment, the user may modify at least one of the network addresses of primary data objects contained in the secondary data object and therefore adapt it to his/her needs. To do this, the user can either have direct access to the secondary data object or can cause the network addresses contained in the secondary data object to be modified automatically or by a person having access to the secondary data object. This can be done e.g. by e-mail or SMS notification to the authorized person or by using a so-called form on a homepage.

In another preferred embodiment, the association of the network addresses of the secondary data objects (secondary network addresses) with the keys of the input device may be permanently specified and may not be modified by the user.

In another preferred embodiment, the user may modify at least one of the associations of the secondary network addresses with the keys of the input device. For example, the user may set directly this association in the program for detecting input detecting, he/she may carry them out in a configuration file of the program for detecting, or he/she may order a different version of the program for detecting input which will use the desired associations.

In another preferred embodiment, the input device is a keyboard. It may comprise additional keys associated with secondary network addresses and/or the keys present on usual keyboards may be associated with secondary network addresses. For the latter case, preferably keys are utilized which are used rarely or not at all, such as the “print screen”, “scroll lock” or “break” keys on a conventional computer keyboard.

In a method for simplified retrieval of data objects according to the present disclosure, in a first step, a key of an input device connected to a computer is activated. In a second step, it is detected by a program for detecting input which key has been activated. In a third step, a network address which is associated with the key activated is transmitted to a network access program. In a fourth step, a secondary data object is loaded by the network access program from the transmitted network address. In doing so, the secondary data object contains the network addresses of at least one primary data object, which the user may access through it.

In a preferred embodiment of the method, the secondary data object contains the network address of exactly one primary data object. In that case the secondary data object may be configured in such a way that the network access program is automatically forwarded to the primary data object. The forwarding may be carried out either without alerting the user so that he/she is not aware of the secondary data object being loaded, or the network access program may indicate that a forward to the primary data object takes place. The secondary data object may be configured in such a way, however, that the network access program displays the network address of the primary data object and the forward is only carried out after being confirmed by the user (e.g. by clicking the mouse on the address of the primary data object or by an input on the keyboard).

In another preferred embodiment of the method, the secondary data object contains the network addresses of a plurality of primary data objects. In that case, the addresses of the primary data objects are displayed by the network access program and the user has to choose which primary data object he/she wishes to access (e.g. by clicking the mouse on the address of the primary data object or by an input on the keyboard).

In another preferred embodiment of the method, the network addresses of primary data objects contained in the secondary data object are permanently specified. The user may not influence which network addresses are displayed to him/her, or to which network addresses he/she is forwarded.

In another preferred embodiment of the method, the user may modify at least one of the network addresses of primary data objects contained in the secondary data object and therefore adapt it to his/her needs. To do this, the user may either have direct access to the secondary data object or may cause the network addresses contained in the secondary data object to be modified automatically or by a person having access to the secondary data object. This can be done e.g. by e-mail or SMS notification to the authorized person or by using a so-called form on a homepage.

In another preferred embodiment of the method, the association of the network addresses of the secondary data objects (secondary network addresses) with the keys of the input device may be permanently specified and may not be modified by the user.

In another preferred embodiment of the method, the user may modify at least one of the associations of the secondary network addresses with the keys of the input device. For example the user may set directly this association in the program for detecting input detecting, he/she may carry them out in a configuration file of the program for detecting, or he/she may order a different version of the program for detecting input which will then use the desired associations.

In another preferred embodiment of the method, the input device is a keyboard. It may have additional keys associated with secondary network addresses and/or the keys present on usual keyboards may be associated with secondary network addresses. For the latter case, preferably keys are employed which are used rarely or not at all, such as for example the “print screen”, “scroll lock” or “break” keys on a conventional computer keyboard.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 is an exemplary embodiment of a keyboard that may be used as an input device.

FIG. 2 is a flow chart of a preferred embodiment of the claimed method.

### DETAILED DESCRIPTION OF THE PREFERRED EMBODIMENTS

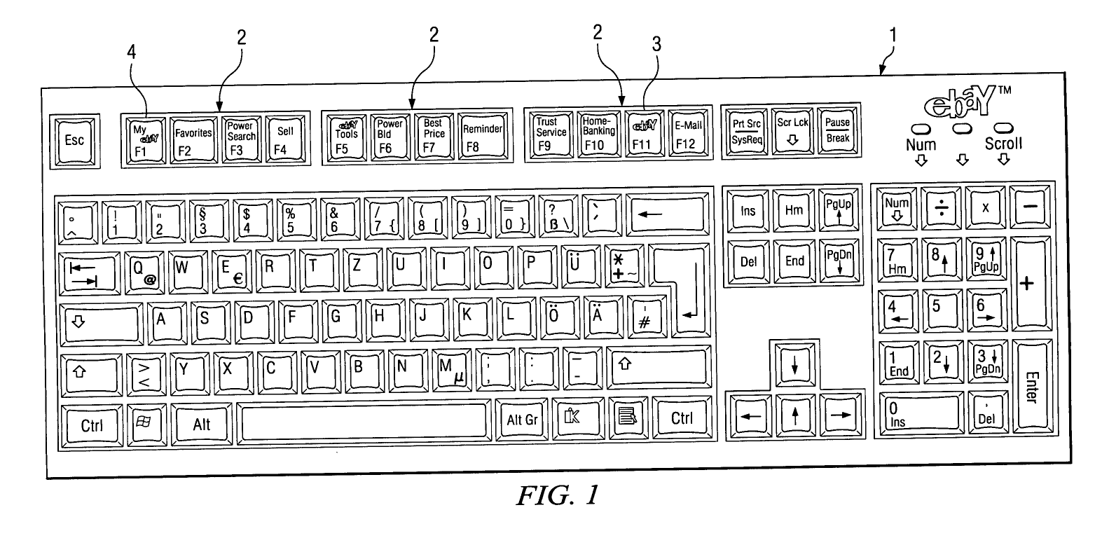

The keyboard (1) shown in FIG. 1 is a computer keyboard which may be used in association with the system or method according to the present disclosure for simplified access to web pages of the internet auctioning platform ebay (ebay is a registered trademark of the firm eBay Inc.).

The keyboard has the usual 105 keys of computer keyboards which all may also be used in the usual way. Additionally, the twelve so-called function keys F1-F12 (2) are labelled, among others, with the names of additional functions, which may be carried out in the ebay context. To do this, it is possible to associate these keys with network addresses in the program for detecting input, from which data objects, in this case web pages, are loaded which forward the user to the corresponding ebay web pages. All the other keys are not associated with network addresses so that these keys keep their usual functions.

If for example the user activates the key F11/“ebay” (3), the program for detecting input transmits the associated secondary network address, e.g. “http://redirect.cherry.de/f11.html” to a browser program. This in turn loads the HTML file “f11.html” (secondary data object) from the computer with the network address “redirect.cherry.de” using the HTTP protocol. This file can be designed in such a way that the browser program is immediately forwarded to the web page with the primary network address “http://www.ebay.de/” and displays it (primary data object).

If the user activates, for example, the key F1/“My ebay” (4), the program for detecting input transmits the associated secondary network address, e.g. “http://redirect.cherry.de/f1.cgi?user=ebayName” to the browser program. Thereby, “ebayName” is the name with which the user is registered with ebay and which may be recorded in the program for detecting input or its configuration file. This name is part of the secondary network address associated with the key F1/“My ebay” (4) as a parameter and is therefore passed to the data object “f1.cgi” causing the browser program to be forwarded to the secondary data object “f1_ebayName.html”, which it loads. This HTML file can be configured in such a way that the browser program is immediately forwarded to the primary data object, i.e. to the “My ebay” web page of the user, which it then displays.

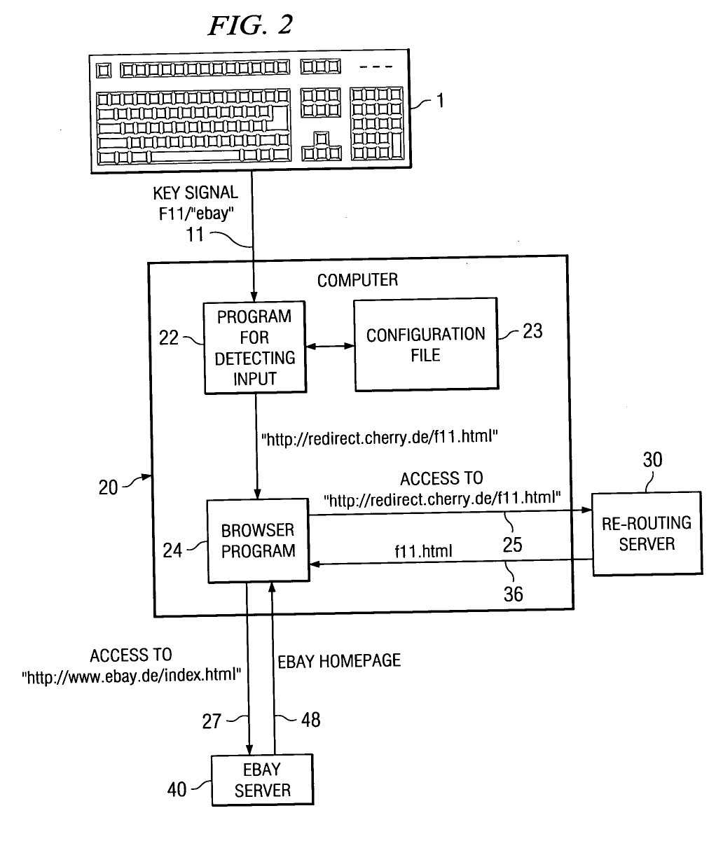

FIG. 2 schematically shows the operating sequence of the method when the user activates the key F11/“ebay” on the keyboard shown in FIG. 1. The signal (11) indicating that the key F11/“ebay” has been activated is received by the program for detecting input (22). This program determines the secondary network address “http://redirect.cherry.de/f11.html” associated with the key by means of its configuration file (23). This address is then transmitted to the network access program, in this case a browser program (24) for the WWW by the program for detecting input.

The browser program (24) accesses the secondary network address (25) and thus loads the secondary data object (26) from the so-called re-routing server (30), in this case a HTML file with the name “f11.html”. This may be composed in such a way that the browser program (24) automatically accesses (27) the primary network address “http://www.ebay.de/index.html” contained in the secondary data object and therefore loads (48) and displays the primary data object with the name of “index.html” from the ebay server (40) with the network address “www.ebay.de”, i.e. the ebay homepage.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A system for use with a computer for simplified retrieval of primary data objects, comprising:
(a) an input device, which can be connected with the computer and comprises at least one key, and
(b) an program for detecting input which may be run on the computer and which comprises:
i) means to detect which key of the input device has been activated, and
ii) means to transmit a network address associated with the activated key to a network access program,
characterized in that
the network access program accesses the transmitted network address and loads a secondary data object from said address containing the network address of at least one primary data object.

2. The system according to claim 1, wherein the secondary data object contains the network address of exactly one primary data object.

3. The system according to claim 2, wherein the network access program is automatically forwarded to the network address of the primary data object after loading the secondary data object.

4. The system according to claim 1, wherein the secondary data object contains the network addresses of more than one primary data object.

5. The system according to claim 1, wherein the network addresses of the primary data objects contained in the secondary data object are permanently specified.

6. The system according to claim 1, wherein at least one of the network addresses of primary data objects contained in the secondary data object may be modified by the user.

7. The system according to claim 1, wherein the association of the secondary network addresses with the keys of the input device is permanently specified.

8. The system according to claim 1, wherein the association of at least one of the secondary network addresses with the keys of the input device may be modified by the user.

9. The system according to claim 1, wherein the input device is a keyboard.

10. A simplified method for simplified retrieval of primary data objects using a computer, comprising the steps of
(a) activating a key of an input device connected to the computer;
(b) detecting which key has been activated by means of a program for detecting input;
(c) transmitting a network address associated with the activated key to a network access program; and
(d) loading a secondary data object from the transmitted network address by means of the network access program,
characterized in that
the secondary data object contains the network addresses of at least one primary data object.

11. The method according to claim 10, wherein the secondary data object contains the network address of exactly one primary data object.

12. The method according to claim 11, wherein the network access program is automatically forwarded to the network address of the primary data object after loading the secondary data object.

13. The method according to claim 10, wherein the secondary data object contains the network addresses of more than one primary data object.

14. The method according to claim 10, wherein the network addresses of the primary data objects contained in the secondary data object are permanently specified.

15. The method according to claim 10, wherein at least one of the network addresses of primary data objects contained in the secondary data object may be modified by the user.

16. The method according to claim 10, wherein the association of the secondary network addresses with the keys of the input device is permanently specified.

17. The method according to claim 10, wherein the association of at least one of the secondary network addresses with the keys of the input device may be modified by the user.

18. The method according to claim 10, wherein the input device is a keyboard.
